(19) United States
(12) Patent Application Publication
(10) Pub. No.: US 2007/0279755 A1
(43) Pub. Date: Dec. 6, 2007

(54) Head-Up Display System

(75) Inventors: Guido Hitschmann, Neuss (DE); Keith M. Kotchick, St. Paul, MN (US); Andrew J. Ouderkirk, Woodbury, MN (US); Kay-Uwe Schenke, Neuss (DE)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/421,574

(22) Filed: Jun. 1, 2006

(51) Int. Cl. G02B 27/14

(52) U.S. Cl. 359/630

(57) ABSTRACT

A head-up display system for a vehicle includes a projector and a combiner in which a multilayer film is provided to reflect a display from the projector to the driver, the display being superimposed on the image of the vehicle surroundings that the driver receives through the vehicle windscreen. The display comprises light within a single restricted frequency band, or a plurality of spaced restricted frequency bands only. The frequency bands are selected to ensure that essential visual information which would normally be conveyed to the driver through the windscreen is not blocked by the multilayer film.

### FIELD OF THE INVENTION

The present invention relates to head-up display systems for use in vehicles.

A head-up display (HUD) system is used in a vehicle to enable information to be presented to the vehicle driver without requiring the driver to look away from the image of the vehicle surroundings that he can view through the vehicle windscreen. HUD systems have been developed particularly for use in high-speed vehicles such as aircraft, especially military aircraft, but are now increasingly being considered as an attractive safety feature for other vehicles, including private automobiles.

### BACKGROUND

A HUD system for a vehicle typically comprises a combiner, which functions as a partial mirror (i.e. a partial reflector and a partial window), together with a projection system that projects information onto the combiner. In the simplest form of HUD system, the vehicle windscreen functions as the combiner. Alternatively, the combiner may comprise a transparent screen on which is deposited a coating that provides the required partial mirror characteristics and which, in use, is located inside the vehicle in the line of sight of the driver when looking ahead through the windscreen so that the driver can see not only the image of the vehicle surroundings (transmitted through the windscreen and then through the combiner) but also the projected information displayed on (i.e. reflected from) the combiner. HUD systems of that type are described, for example, in U.S. Pat. No. 5,194,989 and U.S. Pat. No. 5,576,886. As a further alternative, the combiner may be formed using a suitable optical film that is adhered to a separate transparent screen located inside the vehicle as described above; or directly to the vehicle windscreen; or, if the windscreen is formed from laminated glass, between the laminated glass layers.

HUD systems intended especially for use in automobiles are described, for example, in FR-A-2 689 651; DE-A-33 47 271; and EP-A-0 430 140; 0 421 886, and 0 329 110.

It is a requirement of a HUD system that the displayed information from the projection system should be clearly visible against the image of the vehicle surroundings that the driver receives through the vehicle windscreen. This can be most difficult to achieve in daylight conditions, when the vehicle surroundings are also brightly illuminated, and particularly when the vehicle windscreen is used as the combiner. In that case, not only is there a lack of contrast between the displayed information and the image of the vehicle surroundings but, in addition, the clarity of the displayed information is obscured by the presence of “ghost’ images caused by reflection of the displayed information at both surfaces of the windscreen.

A known solution to the problem of “ghost” images is to wedge the inner and outer surfaces of the windscreen so that the light reflected off one surface is angularly separated from the light reflected off the other surface to the extent that only one of the reflected images is perceived by the vehicle driver.

Systems that enable the visibility of the displayed information to be enhanced through the use of a combiner comprising a multilayer film and a projection system that emits polarized light are described in US 2004/0135742.

### BRIEF SUMMARY

The present invention is concerned with the provision of a HUD system that is capable of displaying the projected information clearly to the driver, and is suitable for use in the case in which the vehicle surroundings include objects which should be seen by the vehicle driver but which emit/reflect light only within only within a single restricted frequency band or spaced restricted frequency bands.

In one aspect, the invention is concerned with the case in which the selected objects actively emit light, for example illuminated traffic signals. In this aspect, the invention provides a head-up display system for a vehicle, comprising: a combiner that functions as a partial reflector, which is positioned in the line of sight of the driver and through which the driver can view the vehicle surroundings including the selected objects; and

a projector that projects a display onto the combiner, the projector emitting light only within a single restricted frequency band or spaced restricted frequency bands; wherein the combiner is positioned to reflect light from the projector to the driver, the reflection characteristic of the combiner being such that it only reflects light at the frequencies emitted by the projector and transmits light at other frequencies; and the/each frequency band within which light is emitted by the projector is such that it does not substantially coincide with any frequency band within which light is emitted by the selected objects.

In another aspect, the invention is concerned with the case in which the objects are illuminated by visible light only within spaced restricted frequency bands emitted by the vehicle headlights. This could be the case, for example, if the light sources of the headlights are light emitting diodes (LEDs). In this aspect, the invention provides a head-up display system comprising: a combiner that functions as a partial reflector, which is positioned in the line of sight of the driver and through which the driver can view the vehicle surroundings; and a projector that projects a display onto the combiner, the projector emitting light only within a single restricted frequency band or spaced restricted frequency bands; wherein the combiner is positioned to reflect light from the projector to the driver, the reflection characteristic of the combiner being such that it only reflects light at the frequencies emitted by the projector and transmits light at other frequencies; and the/each frequency band within which light is emitted by the projector does not substantially coincide with any frequency band within which light is emitted by the vehicle headlight.

In yet another aspect, the invention is concerned with the case in which the objects are illuminated by infra-red radiation within a restricted frequency band emitted by the vehicle headlights. In this aspect, the invention provides a head-up display system comprising: a combiner that functions as a partial reflector, which is positioned in the line of sight of the driver and through which the driver can view the vehicle surroundings; and a projector that projects a display onto the combiner, the projector emitting light only within a single restricted frequency band or spaced restricted frequency bands; wherein the combiner is positioned to reflect light from the projector to the driver, the reflection characteristic of the combiner being such that it only reflects light at the frequencies emitted by the projector and transmits light at other frequencies; and the/each frequency band within which light is emitted by the projector does not substantially coincide with any frequency band within which light is emitted by the vehicle headlight.

### BRIEF DESCRIPTION OF THE DRAWINGS

By way of example only, HUD systems in accordance with the invention will be described with reference to the accompanying drawings, in which:

FIG. 1 illustrates, diagrammatically, a conventional HUD system;

FIG. 2 illustrates, the optical characteristics of the combiner of the system of FIG. 1;

FIG. 3 illustrates, diagrammatically, a HUD system incorporating an optical film having particular properties;

FIG. 4 illustrates, diagrammatically, a HUD system of the type shown in FIG. 3 deployed in an automobile having LED headlights;

FIG. 5 is similar to FIG. 2 and illustrates the optical characteristics of the combiner of the combiner of the system of FIG. 4;

FIG. 6 is similar to FIG. 4 but illustrates the HUD system deployed in an automobile in which the headlights emit a beam of infra-red radiation in addition to a beam of visible light.

### DETAILED DESCRIPTION OF ILLUSTRATIVE EMBODIMENTS

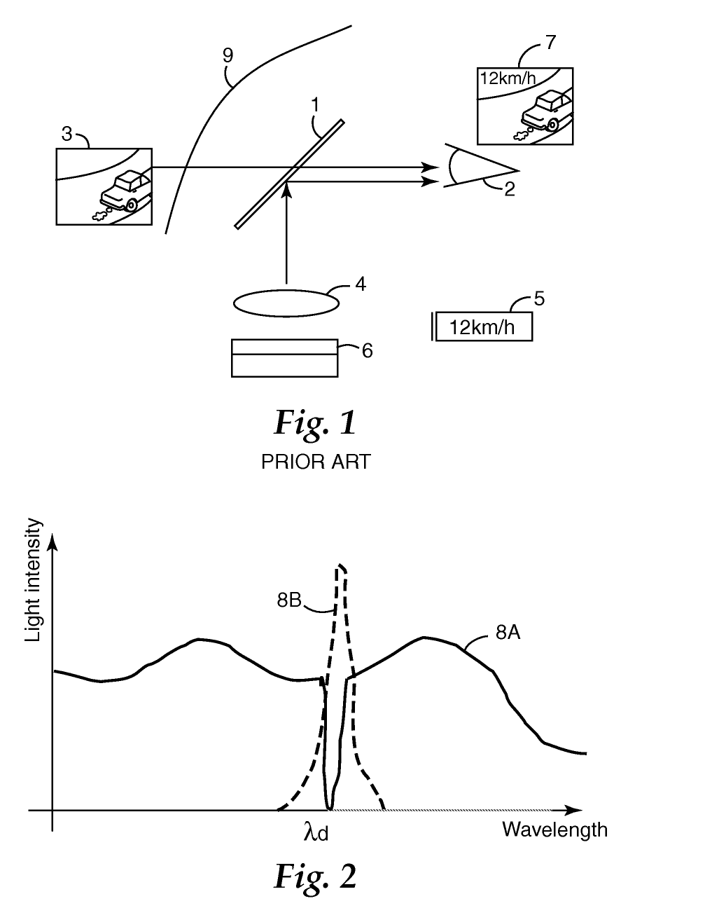

FIG. 1 illustrates the basic components of a conventional HUD system in a vehicle. The system comprises a combiner 1 positioned in the normal line of sight of the driver (whose eyes are indicated diagrammatically at 2) when in control of the vehicle. The combiner should not, of course, impede the driver's view of the vehicle surroundings 3. A projector (represented by a lens 4) projects an image 5 from a backlit display 6 onto the combiner 1 so that it will also be received by the driver's eyes 2 following reflection by the combiner. That display image 5 is here assumed to be a monochrome computer-generated image that provides the driver with important navigation data (here illustrated as being information on the speed of the vehicle). The driver will thus perceive the display image 5 as being superimposed on his view of the vehicle surroundings 3, as illustrated by the combined image 7.

The combiner 1 is a partial mirror that is selected not only to reflect the computer-generated image 5 but also to ensure that the driver can view the vehicle surroundings 3 sufficiently well to allow him to drive the vehicle safely. In some HUD systems, the vehicle windscreen functions as the combiner but, in FIG. 1, the combiner 1 is shown as a separate viewing window, positioned inside the vehicle windscreen 9 in the direct line of sight of the driver. The partial-mirror characteristics of the combiner 1 may be provided by a coating deposited on, or an optical film adhered to, the viewing window. As an alternative, the coating or the optical film may be applied directly on the windscreen 9 or, if the windscreen 9 is formed from laminated glass, between the laminated glass layers.

To enhance the contrast perceived by the vehicle driver between the display image 5 as reflected from the combiner 1 and the image of the surroundings 3 as transmitted by it, the coating or optical film of the combiner is selected to reflect the incident light from the projector 4 and to transmit light at all other wavelengths. The effect of this is illustrated in FIG. 2, in which the solid line 8A represents the transmission characteristics of the optical film/coating and the broken line 8B represents its reflection characteristics. It can be seen that, at the wavelength λ_{d} (representing the incident light from the projector 4), the amount of light reflected by the optical film/coating is at a maximum and the amount transmitted is at a minimum: the image of the display 5 will consequently contrast well with the image of the vehicle surroundings 3, so that it can readily be perceived by the vehicle driver. The combiner will, of course, alter the colour of the image that the driver receives of the vehicle surroundings, to a greater or lesser extent depending on the wavelengths that are not transmitted by the optical film/coating, but is designed to ensure that the image is otherwise as accurate as possible.

In practice, if the combiner 1 comprises a multilayer optical film as described below, the wavelength λ_{d} on which the narrow reflection band of the combiner is centred may not correspond exactly to wavelength of the monochromatic display 5 but may need to be shifted slightly to take account of the position of the projector 4 because the reflection characteristics of a multilayer film vary slightly with the angle of the incident light (in particular, with increasing angles of incidence, the band edge of a multilayer film typically shifts towards the blue end of the spectrum). For simplicity, however, it will be assumed in the remainder of the description that the wavelength λ_{d} on which the narrow reflection band of the combiner 1 is centred does correspond to wavelength of the monochromatic display 5.

As an extension of the above, in the case in which the image 5 that is to be reflected by the combiner 1 is a two- or three-colour image (for example red, green and blue), rather than a monochromatic image, the optical film/coating of the combiner 1 should be able to reflect light at the two or three wavelengths of the image 5 and to transmit light at all other wavelengths. Alternatively, the image 5 may be a full colour image but the projector 4 may be one that uses, as a light source, a combination of light emitting diodes (LEDs) each of which emits a beam of substantially monochromatic light at a selected frequency such that the output of the combination approximates to white light. The light source of the projector may, for example, comprise a combination of LEDs emitting red, green and blue light, in which case the optical film/coating of the combiner 1 should be able to reflect light at those three wavelengths and to transmit light at all other wavelengths.

The above-mentioned US 2004/0135742 describes a HUD system in which a multilayer film, incorporated in a window, is used to provide a combiner having the optical characteristics described above with reference to FIG. 2. US 2004/0135742 also describes the use of a projection system that uses polarized light to form the display image 5, with the projector being positioned to reduce/eliminate the effect known as “ghosting” caused by unwanted reflections of the image 5 at the surfaces of the window.

When a HUD system of the type shown in FIG. 1 is implemented in an automobile, the optical characteristics of the combiner are advantageously provided by a suitable optical film that is either incorporated into the windscreen between the layers of the laminated glass from which the windscreen is constructed, or laminated between two sheets of transparent polymeric material to provide a separate viewing window which, like the combiner 1 of FIG. 1, is positioned inside the vehicle windscreen in the direct line of sight of the driver. In the latter case, the film will be readily compatible with the polymeric cover sheets, being itself formed from polymeric materials, and the resultant article will be light in weight and preferable, from a safety perspective, to one in which the cover sheets are made of glass. A separate viewing window offers the further advantage that it enables the construction of the combiner and its position in the HUD system to be optimized for both the automobile and the user. In either case, the film may extend across the entire area of the automobile windscreen, or it may just occupy a limited area in the direct line of sight of the driver.

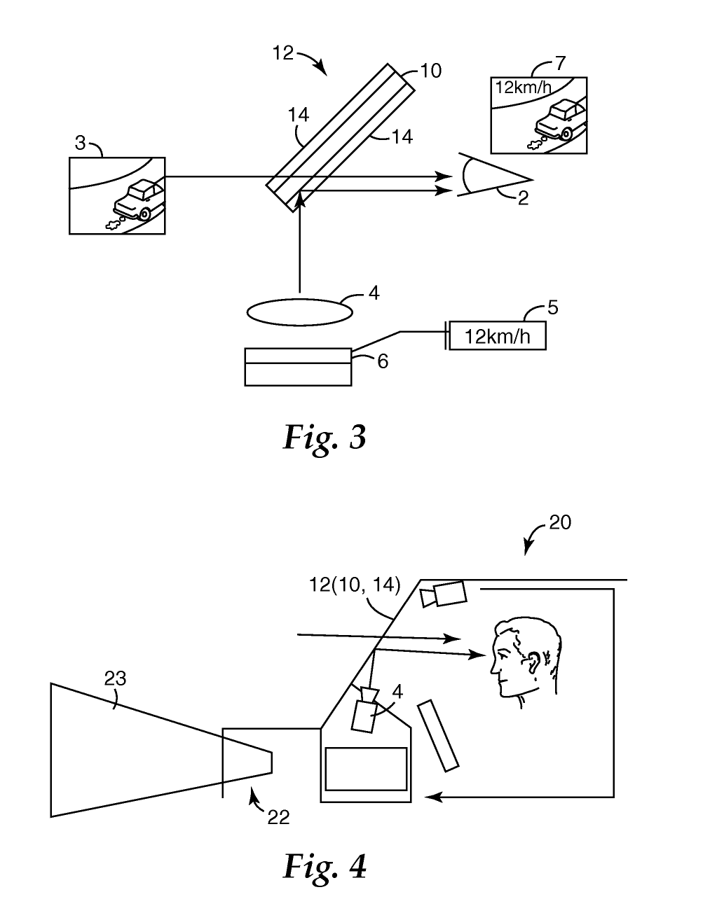

FIG. 3, for example, illustrates a HUD system implemented in an automobile, in which the optical film 10 of the combiner is incorporated into the automobile windscreen 12 between the layers 14 of the laminated glass from which the windscreen is constructed.

The optical film 10, whether incorporated in the automobile windscreen as shown in FIG. 3, or laminated between transparent cover sheets to form a separate viewing window, may be composed of a single film with one or more narrow reflection ranges, or may be composed of multiple films, each with a unique narrow reflection range, stacked or laminated together to provide multiple reflection bands. Preferably, the optical film 10 is a multilayer optical film, the characteristics of which have been tailored through a suitable selection of the film layers to meet the requirements of the HUD system in question. Multilayer films comprising alternating layers of two or more polymers are described, for example, in WO 95/17303 and WO 96/19347 and the use of such films as specular reflectors or polarizing reflectors is known. It is also known that the reflection and transmission characteristics of such multilayer films are determined primarily by the optical thickness of the individual polymer layers and, consequently, that films can be specifically designed to reflect light of particular wavelengths. In addition, WO 99/36809 describes how a multilayer optical film can be designed to exhibit narrow reflection bands with sharp edges and high maximum reflectivity values.

With a view to implementing an efficient HUD system in an automobile in a cost-effective manner, the multilayer optical film 10 could, for example, be a suitably-modified version of the specular-reflector film available under the trade name “Radiant Mirror Film” or the polarizing-reflector film available under the trade name “Dual Brightness Enhancement Film”, both from 3M Company of St. Paul, Minn., U.S.A. Films of that type offer the advantage that they can readily be designed, through a suitable selection of the film layers, to reflect only a comparatively narrow range of wavelengths around the/each wavelength λ_{d} in the display image 5 and, as a result, will cut out less light from the image of the surroundings 3 that is transmitted to the driver through the film 10. For example, it is possible to restrict the wavelengths reflected by the film 10 to those within about 10 nm on either side of the/each wavelength in the display image 5. Such films, when used as described above with reference to FIG. 3, accordingly offer the possibility of providing HUD systems in a quantity and at a price that are suited to the mass automobile market. The HUD system can be readily adapted to the requirements of a particular automobile simply by modifying the layers of the multilayer film 10 so that it possesses the required reflection and transmission characteristics to ensure (i) that the display image 5 as perceived by the driver contrasts well with the image 3 of the vehicle surroundings and (ii) that the driver's view of his surroundings is altered as little as possible.

Although both specular and polarizing-reflector films can be used to advantage, one or the other may be preferred in certain circumstances. A specular-reflector film, for example, may be preferred when the maximum contrast is required between the display image as reflected from the optical film 10 and the image of the vehicle surroundings as transmitted by it. A polarizing reflector, on the other hand, may be preferred when the driver wears polarized sunglasses, for the reasons explained in the above-mentioned US 2004/0135742.

It is additionally necessary to ensure that the reflection and transmission characteristics of the multilayer film 10 do not prevent significant visual information originating outside the vehicle from reaching the driver. This could occur, for example, if the information is conveyed by visible light having a wavelength that the multilayer film is designed to reflect (i.e. light having a wavelength at, or around, a wavelength λ_{d} in the display image 5). To eliminate this risk, the projector 4 of the HUD system should be designed to ensure that none of the wavelengths λ_{d} in the display image 5 corresponds to the wavelength of any significant visual information that the driver can be expected to receive from sources outside the vehicle. That information could, for example, be from illuminated traffic signals that emit visible light only within a single restricted frequency band or spaced restricted frequency bands.

A related situation can arise when an automobile is being driven at night and the image that the driver receives through the windscreen is of the vehicle surroundings illuminated by the vehicle headlights. The light sources that have conventionally been used in vehicle headlights, which emit a continuous spectrum of light, are increasingly being replaced by combinations of light emitting diodes (LEDs) each of which emits a beam of substantially monochromatic light at a selected frequency such that the output of the combination approximates to white light. A light source may, for example, comprise a combination of LEDs emitting red, green and blue light.

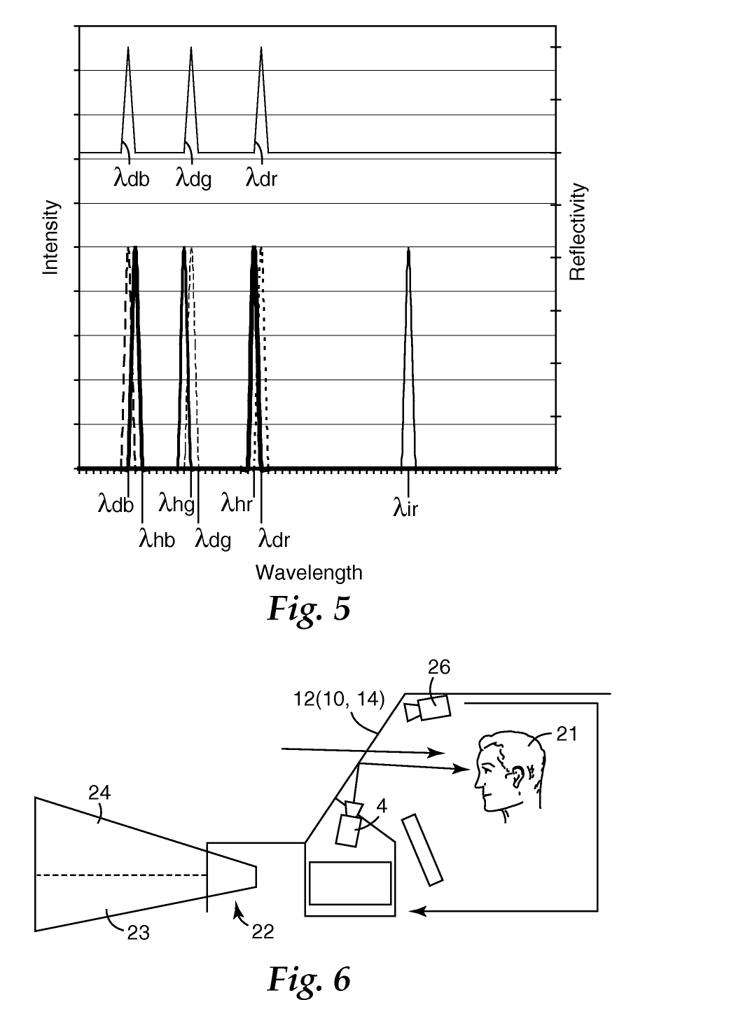

FIG. 4 illustrates, diagrammatically, an automobile 20 equipped with such LED headlights 22 and a HUD system of the type shown in FIG. 3. To enable the HUD system to function during night driving, when the headlights 22 are in use and emitting a beam of visible light 23, the wavelength(s) of the colour(s) selected for the display image 5 (not shown in FIG. 5) and, consequently, the wavelength(s) that the optical film 10 in the windscreen 12 is selected to reflect and not transmit should be shifted relative to the wavelengths of the light emitted by the LEDs of the headlights 22. For example, if the display image 5 is a monochromatic green, λ_{d} in FIG. 2 should be shifted relative to the wavelength of the green LED component of the light from the headlights sufficiently to allow the optical film 10 to reflect the green light from the projector 4 while transmitting the green LED light from the headlamps. The same should apply to other colours, for example red and blue, in the display image 5.

These requirements are illustrated in FIG. 5, for a vehicle in which the light emitted by the vehicle headlights 22 comprises substantially monochromatic components of red, green and blue light of wavelengths λₕᵣ, λ_{hg} and λ_{hb} and the display image 5 from the HUD projector is a three-colour (red, green, blue) image at wavelengths λ_{dr}, λ_{dg} and λ_{db}. The lower part of FIG. 5 shows, in solid lines, the intensity spectrum of the light emitted by LED headlights 22 of a vehicle and, in dotted lines, the intensity spectrum of the light from the HUD projector 4. The upper part of FIG. 5 shows the variation with wavelength of the reflection characteristics of a suitable optical film 10 for the HUD combiner and it will be seen that this has three peaks coinciding with the wavelengths λ_{dr}, λ_{dg} and λ_{db} thereby ensuring that the display image 5 is reflected at maximum intensity. It will also be seen that the wavelengths λₕᵣ, λ_{hg} and λ_{hb} of the substantially monochromatic components of red, green and blue light in the light from the vehicle headlights are spaced sufficiently from the wavelengths λ_{dr}, λ_{dg} and λ_{db} of the display colours to ensure that the light originating from the vehicle headlights is transmitted fully by the optical film 10. There may, as indicated in FIG. 5, be some overlap in practice between the narrow wavelength bands in the light from the vehicle headlights and the narrow wavelength bands in the light from the projector but this overlap should not exceed the level at which it has a deleterious effect on the contrast between the display image as reflected from the optical film 10 and the image of the vehicle surroundings as transmitted by it.

Any suitable optical film can be used as the film 10 in the system of FIG. 4 but, as described above with reference to FIG. 3, the optical film 10 is preferably a suitably-tailored version of the specular-reflector film available under the trade name “Radiant Mirror Film” or the polarizing-reflector film available under the trade name “Dual Brightness Enhancement Film”, providing narrow reflection bands centred on the wavelengths (for example λ_{dr}, λ_{dg} and λ_{db} of FIG. 4) of the display colours. Those reflection bands may, for example, have a width of as little as 20 nm, meaning (i) that the amount by which the wavelengths of the image colours have to be shifted relative to the light from the LEDs of the headlights (when used) is comparatively small and (ii) that the amount of transmitted light blocked by the optical film is comparatively small.

FIG. 6 illustrates an HUD system for an automobile that functions as a night vision system to provide the driver 21 with enhanced information on his surroundings when driving at night. In this case, the headlights 22 of the automobile are provided not only with a source of visible light (which may be either a conventional continuous-spectrum source, or a plurality of single-frequency LEDs as described with reference to FIG. 4) but also with a source of infra-red (IR) radiation 24 in a narrow frequency band (centred, for example, on the wavelength λᵢᵣ in FIG. 5). The IR source may comprise one or more LEDs, or it may comprise a broad-spectrum source in combination with a filter that passes only the IR radiation from the source within a certain narrow frequency band. The IR source may be switched on whenever the headlights 22 are illuminated, or only when the headlights are in dipped-beam (low-beam) mode and may, as indicated diagrammatically in FIG. 6, constitute a specific part only (illustrated here as being the upper part) of the headlight beam. The IR radiation 24 is in the near infra-red spectrum, for which organic surfaces (for example, the coats of animals, and dark natural fibre clothing) are known to be particularly reflective.

Compared to the system of FIG. 4, the HUD system of FIG. 6 additionally comprises, behind the windscreen 12 of the vehicle, a camera 26 that is sensitive to the IR radiation 24 following reflection at an object in front of the vehicle and transmission through the windscreen 12 (including the optical film 10). The image captured by the camera 26 is passed to the HUD projector 4, which projects a visible version of the image onto the HUD combiner (i.e. the optical film 10 in the windscreen 12). In this case, the projector 4 is of a type that uses, as a light source, a combination of light emitting diodes (LEDs) each of which emits a beam of substantially monochromatic light at a selected frequency such that the output of the combination approximates to white light. The light source of the projector may, for example, comprise a combination of LEDs emitting red, green and blue light at wavelengths λ_{dr}, λ_{dg} and λ_{db} and it will be understood that the optical film 10 in the windscreen should be able to reflect light at those three wavelengths so that the driver 21 can see, directly in front of him, the visible version of the IR image captured by the camera 26.

The driver 21 should, of course, also be able to see the image 3 of his surroundings as they appear when illuminated by the visible light from the headlights 22. If the headlights 22 emit a continuous spectrum of light, the optical film 10 in the windscreen 12 should be selected to pass all wavelengths other than those (λ_{dr}, λ_{dg} and λ_{db}) emitted by the LEDs forming the light source of the projector 4. On the other hand, if the light sources of the headlights comprise a combination of LEDs, the wavelength of the light from the individual LEDs (for example, λₕᵣ, λ_{hg} and λ_{hb}) should be shifted relative to the light from the LEDs in the projector 4 to ensure that it can be transmitted through the optical film 10 to the driver 21. In this respect, the system is functioning as illustrated in FIG. 5 and described above.

It must also be ensured, in the HUD system of FIG. 6, that reflected IR radiation is able to pass through the vehicle windscreen to the camera 26. That can be achieved either by providing a suitably-shaped opening in the optical film 10 in the windscreen or, by selecting an optical film that is transmissive for the IR radiation.

Any suitable optical film can be used as the film 10 in the system of FIG. 6 but, as described above with reference to FIG. 3, the optical film 10 is preferably a suitably-tailored version of the specular-reflector film available under the trade name “Radiant Mirror Film” or the polarizing-reflector film available under the trade name “Dual Brightness Enhancement Film”, providing narrow reflection bands centred on the wavelengths (for example λ_{dr}, λ_{dg} and λ_{db} of FIG. 4) of the display colours. As described above, those reflection bands may have a width of as little as 20 nm, meaning (i) that the amount by which the wavelengths of the image colours have to be shifted relative to the light from the LEDs of the headlights (when used) is comparatively small and (ii) that the amount of transmitted light blocked by the optical film is comparatively small. The optical film 10 should also, if necessary, permit the transmission of the IR radiation from the headlights 22: that may be achieved either by designing the film to be transmissive only for the IR radiation emitted by the headlights or, alternatively, over a broad IR range.

Through the use of a system as illustrated in FIG. 6, the vehicle driver is enabled to see not only objects that are illuminated by the visible light from the vehicle headlights 22 but also, superimposed thereon by the projector 4, an image of objects that are less visible in that light. The superimposition of the projected image on the “real” image can be optimized, for a particular position of the driver's eyes, through adjustment of the positions of the camera 26 and projector 4 and by adaptation of the image processing software in the camera. The optimization can be effected automatically, for which a detector of the driver's eye position will be required, or by the driver himself.

The camera 26 may be of any suitable type capable of receiving IR images and converting them into visible images for the projector 4: it may, for example, be a camera that uses solid state detectors such as CMOS (complementary metal oxide semiconductor) detectors or charged coupled devices (CCDs). The sensitivity spectrum of the camera should, of course, be matched to the spectrum of IR radiation that it will receive.

If desired, the HUD systems of FIGS. 4 and 6 can be combined so that the driver 21, without diverting his eyes from the normal driving position, will receive the night vision information provided as in the system of FIG. 6 together with the navigation information provided as in the system of FIG. 4.

In the HUD systems of FIGS. 3, 4 and 6, the effect of multiple images resulting from reflections at the outer surfaces of the laminated windscreen 12, which the driver may perceive as “ghosting”, can be reduced by forming the internal polyvinyl butyl (PVB) layer of the laminate with a wedge-shape as described, for example, in EP-A-0 420 228.

As a further modification, in the systems of FIGS. 3, 4 and 6, the optical film 10 could simply be applied to an external surface of the windscreen 12 (or separate viewing window, if used) although that is less preferable.

Various other modifications and alterations will be apparent to those skilled in the art without departing from the scope and spirit of the invention and it should be understood that the invention is not limited to the illustrative embodiments described above.

What is claimed is:

1. A head-up display system for a vehicle, which also permits the vehicle driver to view selected objects that emit visible light only within a single restricted frequency band or spaced restricted frequency bands, the system comprising:
a combiner that functions as a partial reflector, which is positioned in the line of sight of the driver and through which the driver can view the vehicle surroundings including the selected objects; and
a projector that projects a display onto the combiner, the projector emitting light only within a single restricted frequency band or spaced restricted frequency bands;
wherein the combiner is positioned to reflect light from the projector to the driver, the reflection characteristic of the combiner being such that it only reflects the incident light from the projector and transmits light at other frequencies; and
the/each frequency band within which light is reflected by the combiner does not substantially coincide with any frequency band within which light is emitted by the selected objects.

2. A system as claimed in claim 1, in which the selected objects include illuminated traffic signals.

3. A system as claimed in claim 1, in which the combiner comprises an optical film which functions as a partial reflector.

4. A system as claimed in claim 3, in which the optical film is a multilayer optical film.

5. A system as claimed in claim 4, in which the multilayer optical film is a specular reflector or a polarizing reflector.

6. A system as claimed in claim 3, in which the optical film is laminated between transparent sheets of material.

7. A system as claimed in claim 6, in which the vehicle has a laminated glass windscreen and the optical film is located between the glass layers of the windscreen.

8. A system as claimed in claim 6, in which the optical film is located between sheets of polymeric material to form a viewing window that is located inside the vehicle.

9. A system as claimed in claim 1, in which the light source of the projector comprises at least one light emitting diode, the/each diode emitting a substantially monochromatic beam of light.

10. A head-up display system for a vehicle equipped with a headlight that emits visible light only within spaced restricted frequency bands, the system comprising:
a combiner that functions as a partial reflector, which is positioned in the line of sight of the driver and through which the driver can view the vehicle surroundings; and
a projector that projects a display onto the combiner, the projector emitting light only within a single restricted frequency band or spaced restricted frequency bands;
wherein the combiner is positioned to reflect light from the projector to the driver, the reflection characteristic of the combiner being such that it only reflects the incident light from the projector and transmits light at other frequencies; and
the/each frequency band within which light is reflected by the combiner does not substantially coincide with any frequency band within which light is emitted by the vehicle headlight.

11. A system as claimed in claim 10, in which the combiner comprises an optical film which functions as a partial reflector.

12. A system as claimed in claim 11, in which the optical film is a multilayer optical film.

13. A system as claimed in claim 12, in which the multilayer optical film is a specular reflector or a polarizing reflector.

14. A system as claimed in claim 11, in which the optical film is laminated between transparent sheets of material.

15. A system as claimed in claim 14, in which the vehicle has a laminated glass windscreen and the optical film is located between the glass layers of the windscreen.

16. A system as claimed in claim 14, in which the optical film is located between sheets of polymeric material to form a viewing window that is located inside the vehicle.

17. A system as claimed in claim 10, in which the visible light emitted by the headlight has the appearance of substantially white light.

18. A system as claimed in claim 10, in which the light source of the headlight comprises a plurality of light emitting diodes, each of which emits a substantially monochromatic beam of light.

19. A system as claimed in claim 10, in which the light source of the projector comprises at least one light emitting diode, the/each diode emitting a substantially monochromatic beam of light.

20. A head-up display system for a vehicle equipped with a headlight that emits a beam of infra-red radiation within a restricted frequency band, the system comprising:
a combiner that functions as a partial reflector, which is positioned in the line of sight of the driver and through which the driver can view the vehicle surroundings;
a camera positioned to receive infra-red radiation from the headlight following reflection by an object outside the vehicle, and operable to convert the infra-red radiation into a visible image of the object; and
a projector that projects the visible image onto the combiner, the projector emitting light only within a single restricted frequency band or spaced restricted frequency bands;
wherein the combiner is positioned to reflect light from the projector to the driver, the reflection characteristic of the combiner being such that it only reflects the incident light from the projector and transmits light at other frequencies.

21. A system as claimed in claim 20, in which the headlight emits visible light only within spaced restricted frequency bands and the/each frequency band within which light is reflected by the combiner does not substantially coincide with any frequency band within which light is emitted by the vehicle headlight.

22. A system as claimed in claim 20, in which the camera is located within the vehicle to receive infra-red radiation transmitted through the combiner.

23. A system as claimed in claim 20, in which the camera comprises solid state detectors to receive the infra-red radiation and convert it into a visible image.

24. A system as claimed in claim 20, in which the combiner comprises an optical film which functions as a partial reflector.

25. A system as claimed in claim 24, in which the optical film is a multilayer optical film.

26. A system as claimed in claim 25, in which the multilayer optical film is a specular reflector or a polarizing reflector.

27. A system as claimed in claim 24, in which the optical film is laminated between transparent sheets of material.

28. A system as claimed in claim 27, in which the vehicle has a laminated glass windscreen and the optical film is located between the glass layers of the windscreen.

29. A system as claimed in claim 27, in which the optical film is located between sheets of polymeric material to form a viewing window that is located inside the vehicle.

30. A system as claimed in claim 20, in which the visible light emitted by the headlight has the appearance of substantially white light.

31. A system as claimed in claim 20, in which the light source of the headlight comprises a plurality of light emitting diodes, each of which emits a substantially monochromatic beam of light.

32. A system as claimed in claim 20, in which the source of infra-red radiation comprises at least one light-emitting diode.

33. A system as claimed in claim 20, in which the light source of the projector comprises at least one light emitting diode, the/each diode emitting a substantially monochromatic beam of light.
